(19) United States
(12) Patent Application Publication
(10) Pub. No.: US 2024/0193998 A1
(43) Pub. Date: Jun. 13, 2024

(54) LICENSE PLATE PAYMENT SYSTEM AND COMPUTER-IMPLEMENTED METHOD

(71) Applicant: Amid Elkhoury, Allston, MA (US)

(72) Inventor: Amid Elkhoury, Allston, MA (US)

(21) Appl. No.: 18/528,833

(22) Filed: Dec. 5, 2023

Related U.S. Application Data
(60) Provisional application No. 63/430,685, filed on Dec. 7, 2022.

(51) Int. Cl. G07B 15/06; G06F 21/60; G06Q 20/08; G06Q 20/40; G06V 20/62; G06V 30/10

(52) U.S. Cl. CPC G07B 15/063; G06F 21/602; G06Q 20/0855; G06Q 20/4014; G06V 20/625; G06V 30/10

(57) ABSTRACT

The present invention relates to a license plate scanning and payment system and method of use thereof. The system includes a server coupled to a mobile application, wherein the server is configured to store license plate information and associated payor or credit card account (i.e., payment information) in a database. The application enables a user to capture and upload license plate and credit card account information. The license plate positioned on the vehicle is scanned by a scanning endpoint and the scanned information is compared with the information stored in the database for debiting a payment from the credit card account. The system keeps records for payment summaries and can show pricing offered by various service facilities.

### CROSS-REFERENCE TO RELATED APPLICATION

The present application claims priority to, and the benefit of, U.S. Provisional Application No. 63/430,685, which was filed on Dec. 7, 2022, and is incorporated herein by reference in its entirety.

### FIELD OF THE INVENTION

The present invention relates generally to the field of license plate reading systems. More specifically, the present invention relates to a novel system and method of making and receiving payments based upon scanning of a vehicle license plate. The license plate is associated with a credit card and upon scanning of the license plate, the credit card is charged with a predetermined amount. A user can use a mobile application to upload license plate image and credit card information. The system enables individuals to make payments quickly, or in real time, at a location. Accordingly, the present disclosure makes specific reference thereto. Nonetheless, it is to be appreciated that aspects of the present invention are also equally applicable to other like applications, devices, and methods of manufacture.

### BACKGROUND

By way of background, parking sites, sports stadiums, toll roads, car washing, and servicing areas and more are becoming more automated. However, such sites are installed with tag readers to avoid manual collection of charges for which users need to install special tags on their vehicles or alternatively pay through cash or with a credit card. Individuals need to keep such tags recharged which is cumbersome. Many times, individuals may forget to recharge such tags.

Due to manual payment collection, waiting in line to make payments at busy retail stores, concession stands at a stadium, parking lots, etc. can be incredibly frustrating and time consuming. Individuals desire a new method and system for making payments quickly without manually paying money so that they can continue about their day after completing their shopping/purchasing tasks. Many times, individuals do not know the pricing offered by different services which can result in a cumbersome situation when individuals do not carry enough money.

License plate readers are commonplace, but they are typically used for verification of the license plates and associated vehicle registrant. There is a need for an improved license plate reading system that can be used for automatic payments from users and/or vehicle registrants in a secure manner.

Therefore, there exists a long-felt need in the art for a system capable of making and receiving payments based on a user's license plate. There is also a long-felt need in the art for a system that enables individuals to make payments quickly, and/or in real time, at a remote location rather than waiting in line at busy retail establishments. Additionally, there is a long-felt need in the art for a system that can show pricing offered by various service facilities. Moreover, there is a long-felt need in the art for a system that enables individuals to pay for services that utilize a vehicle's license plate. Finally, there is a long-felt need in the art for a system and method that enables individuals to associate a payment method with their license plates enabling services to scan the license plate for receiving the desired payment.

The subject matter disclosed and claimed herein, in one embodiment thereof, comprises a license plate payment system for scanning license plates to facilitate automatic payments for a service area. The system comprising a computer-implemented server having an OCR module and a batch processor, a mobile application configured to provide a user interface for inputting a license plate image and credit card information, a payment module, a database configured to store credit card information and associated license plate numbers, wherein a license plate is scanned by a scanning endpoint and the scanned license plate is processed by the OCR module to retrieve the license plate number, the retrieved license plate number is compared with the license plate numbers stored in the database and the credit card associated with the matched license plate number is charged with a predetermined amount by the payment module. The batch processor is configured to process the payments periodically for transferring to the service area vendors.

In this manner, the system and associated method of the present invention accomplish all of the forgoing objectives and provide users with a system and method capable of making and receiving payments based on a user's license plate. The system eliminates manual payments at exits of retail stores, toll gates/roads/bridges, sports stadiums, event parking, and more. The system enables scanning of the license plates for secure transactions with a predetermined amount.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for making a payment using an image scan of a vehicle license plate. The method comprising the steps of acquiring an image of the license plate of a user's vehicle, including the license plate number; receiving credit card information of the user; linking the credit card information with the acquired license plate; scanning, by a scanning endpoint, the license plate of the vehicle; automatically charging, the received credit card, for a predetermined amount; and, providing a notification to the user for the deducted amount.

In a further embodiment of the present invention, a method of payment for toll roads, parking, car washes, and other vehicle related services that utilizes a vehicle's license plate is described. The method comprising the steps of receiving, by a mobile application, registration information of a user; wherein, the registration information includes vehicle license plate image and credit card information; storing, by a database, the received license plate information and credit card information; scanning, by a scanning endpoint, the license plate positioned in front or rear of a vehicle; comparing the scanned image of the license plate with the stored image of the license plate; and, deducting, by a payment module, a predetermined amount from the stored credit card.

In a further embodiment of the present invention, a license plate payment system is disclosed. The system comprising a computer-implemented server having an OCR module and a batch processor, a mobile application configured to provide a user interface for inputting license plate image and credit card information, a payment module, a database configured to store credit card information and associated license plate numbers, wherein a license plate is scanned by a scanning endpoint and the scanned license plate is processed by the OCR module to retrieve license plate number, the retrieved license plate number is compared with the license plate numbers stored in the database, and credit card information associated with the matched license plate number is charged with a predetermined amount.

In yet another embodiment, the computer-implemented application displays payment summaries associated with a license plate number and associated registrant.

In yet another embodiment, the computer-implemented application shows predetermined pricing offered by different service and parking facilities near the location of the vehicle.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of a license plate payment system of the present invention in accordance with the disclosed architecture;

FIG. 2 illustrates a flow diagram depicting a process of linking a credit card or any other financial payment card to the vehicle license plate in accordance with the disclosed architecture;

FIG. 3 illustrates a flow diagram depicting a process of using the vehicle license plate for making a payment in accordance with the disclosed architecture;

FIG. 4 illustrates a flow diagram depicting a process of batch processing of payments by the system of the present invention in accordance with the disclosed architecture;

FIG. 5 illustrates a perspective view showing the scanning of a license plate by an exemplary scanning point for automatically deducting payment in accordance with the disclosed architecture;

FIG. 6 illustrates a flow diagram depicting a process of registration of a scanning endpoint in the system of the present invention in accordance with the disclosed architecture;

FIG. 7A illustrates an exemplary user interface offered by the license plate payment application of the present invention for selecting and capturing a license plate for the payment in accordance with the disclosed architecture;

FIG. 7B illustrates another user interface offered by the license plate payment application of the present invention for adding credit card information for the payment in accordance with the disclosed architecture; and

FIG. 8 illustrates the exemplary user device that is used for installing the software application of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a system capable of making and receiving payments based on a user's license plate and an associated registrant. There is also a long-felt need in the art for a system that enables individuals to make payments quickly, and/or in real time at a remote location rather than waiting in line at busy retail establishments or parking facilities. Additionally, there is a long-felt need in the art for a system that can show pricing offered by various service and parking facilities. Moreover, there is a long-felt need in the art for a system that enables individuals to pay for services that utilize a vehicle's license plate and associated vehicle/registrant. Finally, there is a long-felt need in the art for a system and method that enables individuals to associate a payment method with their license plates thereby enabling services to scan the license plate for receiving the desired payment.

The present invention, in one exemplary embodiment, is a method of payment for toll roads, parking facilities, car washes, events, and other vehicle related services that utilizes a vehicle's license plate. The method comprising the steps of receiving, by a mobile application, registration information of a user; wherein, the registration information includes vehicle license plate image and credit card information; storing, by a database, the received license plate information and credit card information; scanning, by a scanning endpoint, the license plate positioned in front or rear of a vehicle; comparing the scanned image of the license plate with the stored image of the license plate; and, deducting, by a payment module, a predetermined amount from the stored credit card.

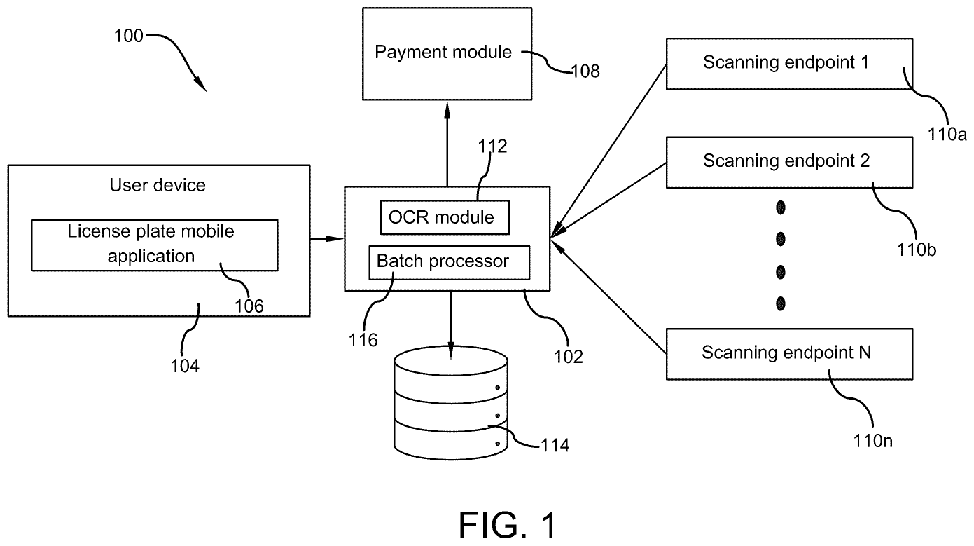

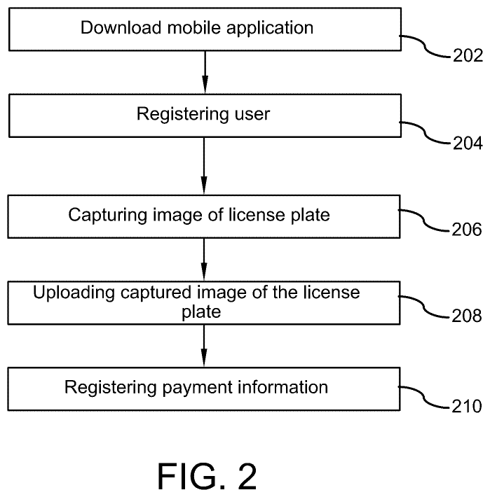

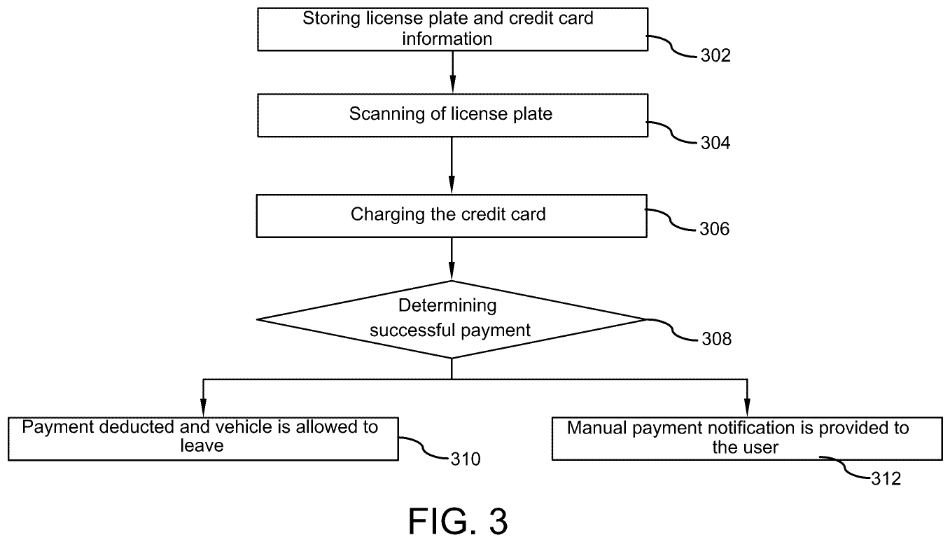

Referring initially to the drawings, FIG. 1 illustrates a schematic view of the license plate payment system of the present invention in accordance with the disclosed architecture. The system 100 facilitates use of a server 102 for enabling use of a mobile device 104 to make payments quickly, or in real time, at a location using scanning of the license plate of a vehicle. In general, the mobile device 104 includes a license plate payment application 106 that enables the user of the mobile device 104 to enter and submit a vehicle license plate and a credit card for automatically making payments upon successful scanning of the license plate. The server 102, using an integrated, connected, or third-party secure payment module 108, facilitates automatic payment from the credit card registered by a user as illustrated in FIGS. 2 and 3.

The application 106 is configured to provide a user interface for enabling a user to register the license plate and credit card in the system 100. An image of the license plate can also be uploaded in the system for storage as discussed in detail later in the disclosure. For scanning of the licensing plate positioned in front and/or rear of a vehicle, a plurality of scanning endpoints 110a-n is registered in the system 100. When a scanning endpoint scans a registered license plate, the information of the scanned license plate is received by the server 102 from the scanning endpoint. The server 102 has an optical character recognition (OCR) module 112 for retrieving the license plate number from the scanned image for authentication. The scanning endpoints 110a-n are maintained by independent vendors, toll services, parking services, event parking facilities, and more which are registered in the system 100 for taking advantage of the services offered by the system 100.

The system 100 has a secure and encrypted registration database 114 for storing the registered license plate numbers and credit card information. The database 114 maintains a correspondence, association, or linkage between a license plate number and credit card number enabling the payment module 108 to charge the credit card with an appropriate or debit amount upon scanning of the license plate by a scanning end point. For providing payment to the vendors whose scanning endpoints 110a-n are registered with the system 100, a batch processor 116 is included in the server 102 where an identifier of the vendor/scanning endpoint is used for identifying the vendor and the amount for the scanned license plates is credited in the registered account of the vendor.

The system 100 enables the users to connect and associate a credit card to the respective license plate such that when the license plate is scanned, the associated credit card is charged for a specific amount by a business or facility. In some embodiments, the database 114 stores license plate numbers that can be retrieved by the OCR module 112 and payment module 108. In other embodiments, the database 114 stores encoded images of license plates uploaded by the user during the time of registration as described in FIG. 2.

In some embodiments, the scanning endpoints 110a-n may use radio link using a near field communication (NFC) protocol, such as that specified by ISO/IEC 18000-3 which has an effeetive range of about 10 cm and operates at 13.56 MHz for scanning the license plate. In other embodiments, the scanning endpoints 110a-n may have registered high-definition cameras for scanning and capturing the license plates. The communication of the mobile device 104 and scanning points 110a-n with the server 102 can be actuated using one or more types of wireless communication signals and/or systems, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, discrete multi-tone (DMT), Bluetooth (®), global positioning system (GPS), Wi-Fi, ZigBee™, global system for mobile communication (GSM), 2G, 2.5G, 3G, 3.5G, 4G, 5G, 6G or the like.

The server 102 can be a centralized server, a distributed server, a cloud server, or the like. The server 102 is configured to provide the user interfaces and functionality to the users of the system 100 using a plurality of integrated software and hardware modules as described in the present disclosure. It should be appreciated that the system 100 and the application 106 allow users to use their vehicle's license plate as a means for paying quickly at a location rather than waiting in line at busy retail stores, sports stadiums, parking lots, event venues, and more. The system 100 can be used by businesses, parking vendors, retail stores, and more that relates to a vehicle's license plate to automatically scan and deduct payment and thereby reducing time at the entry and/or exit points.

FIG. 2 illustrates a flow diagram depicting a process of linking a credit card or any other financial payment card to an associated vehicle license plate in accordance with the disclosed architecture. Initially, a user downloads the vehicle license plate payment application in the electronic device (Step 202). The application is configured to provide the required user interfaces for enabling a user to register a license plate and credit card for facilitating payments. Then, the user registers himself in the system by inputting personal information including, but not limited to, name, address, age, SSN, and more (Step 204). Thereafter, upon successful registration, the user aims the imaging device or camera of the device on a vehicle license plate to capture image of the license plate (Step 206). The front-face showing the plate number is scanned or captured by the application using the camera of the electronic device. Then, the user uploads the vehicle license plate image to link the license plate with the profile of the user in the system (Step 208).

Thereafter, the user includes payment information (i.e., payor account) in the form of a credit card or any other financial card to link the payment information or payor account with the license plate (Step 210). The registered payment information is used for payment when the license plate is scanned by a reader such as a toll reader, parking payment POS, and more.

FIG. 3 illustrates a flow diagram depicting a process of using the vehicle license plate for making a payment in accordance with the disclosed architecture. Initially, the system registers a vehicle license plate with a credit card and securely stores the information in the internal database (Step 302). Then, a reader or camera installed at a premises such as at a toll, stadium, parking, venue, and more scans the vehicle license plate as the vehicle enters and/or exits the premises (Step 304). The readers are configured to communicate with the server for providing the scanned information for authorization. Then, the credit card associated with the scanned license plate is charged for an appropriate or debit amount (Step 306). Thereafter, determination of a successful payment is made by the system for enabling the vehicle to leave the premises (Step 308). In situations where the payment is successful upon authorization of the credit card information stored in the database, the vehicle is allowed to enter or leave the premises (Step 310). In situations where the payment is failed due to failure of any financial check or background verification, then, a notification to the user device is provided for instructing and performing a manual payment before entering or leaving the premises (Step 312).

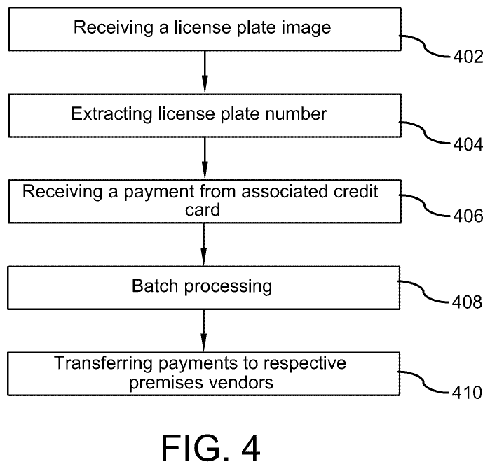

FIG. 4 illustrates a flow diagram depicting a process of batch processing of payments by the system of the present invention in accordance with the disclosed architecture. The authorization of license plate images and processing of payments are done by the system centrally or in a distributed manner as per requirements of users and design of the system. Initially, the server receives a license plate image from a scanning endpoint (Step 402). The system is designed to handle and process all conventional types of vehicle license plates and can be configured to handle new types of license plates as well. Using a conventional technique such as optical character recognition (OCR), the server extracts the license plate number from the received image for verifying authenticity of the license plate (Step 404). Once verification is complete, a payment is received from the credit card associated with the license plate number (Step 406).

For providing payments to different vendors whose scanning endpoints are registered with the system, the system 100 uses a batch processing at a predetermined interval such as daily, weekly and the like (Step 408). Once a batch processing is successfully performed, then, the payments are transferred to the vendors (Step 410). In some embodiments, the system 100 may charge a commission fee from the vendors for providing them the service of payment using the license plate of the vehicles.

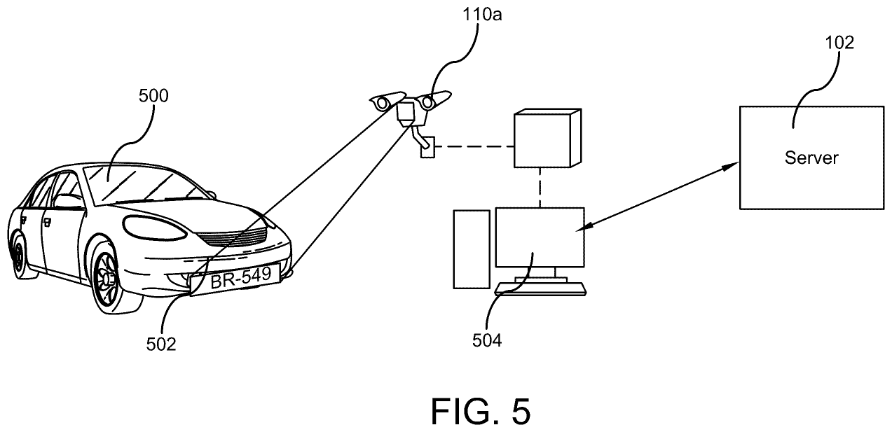

FIG. 5 illustrates a perspective view showing the scanning of a license plate by an exemplary scanning point for automatically deducting payment in accordance with the disclosed architecture. The system 100 can be used for toll roads, parking, events, venues, garages, car washes and other vehicle related services that utilizes a vehicle's license plate. As illustrated, a license plate 502 of a vehicle 500 is scanned by the exemplary scanning endpoint 110a such that the image of the license plate 502 is captured and is transferred to the server 102 for authorization and payment processing as described earlier in the disclosure.

The premise may have a local computing system 504 enabling an operator to view details of the vehicle 500 and confirmation of the payment from the server 102. It should be noted that both the license plate 502 and the scanning endpoint 110a are registered in the system 100 for avoiding any false transactions. The server 102 in addition to the image of the license plate 502 also receives an identifier of the scanning endpoint 110a for identifying and authorizing the endpoint 110a.

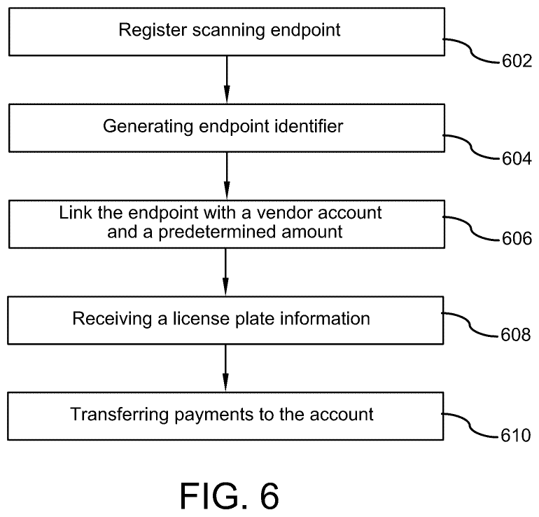

FIG. 6 illustrates a flow diagram depicting a process of registration of a scanning endpoint in the system 100 of the present invention in accordance with the disclosed architecture. Initially, a scanning point is registered by incorporating information including vendor name, location, and more in the system (Step 602). Then, an endpoint identifier is generated by the system 100 for uniquely identifying the scanning endpoint (Step 604). Once, the identifier is generated, then, the endpoint is associated with a vendor account for automatic payment transfer after batch processing and a predetermined amount to be deducted at the endpoint is also associated with the endpoint (Step 606). Information of successfully registered scanning points is added to the one or more databases of the system 100 and is used for authentication of information from the endpoint.

During operation, license plate information is received by the server 102 from the scanning endpoint upon scanning or capturing of a license plate (Step 608). Finally, after successful processing of payment and batch processing, the payments associated with the endpoint are transferred to the vendor account (Step 610). In some of the embodiments of the present invention, an operator at the scanning endpoint can raise a request for an amount different from the predetermined amount and an approval request is sent to the mobile device having the application 106. Upon approval of the request, the amount is deducted from the associated stored credit card account and the vehicle enters or exits from the facility.

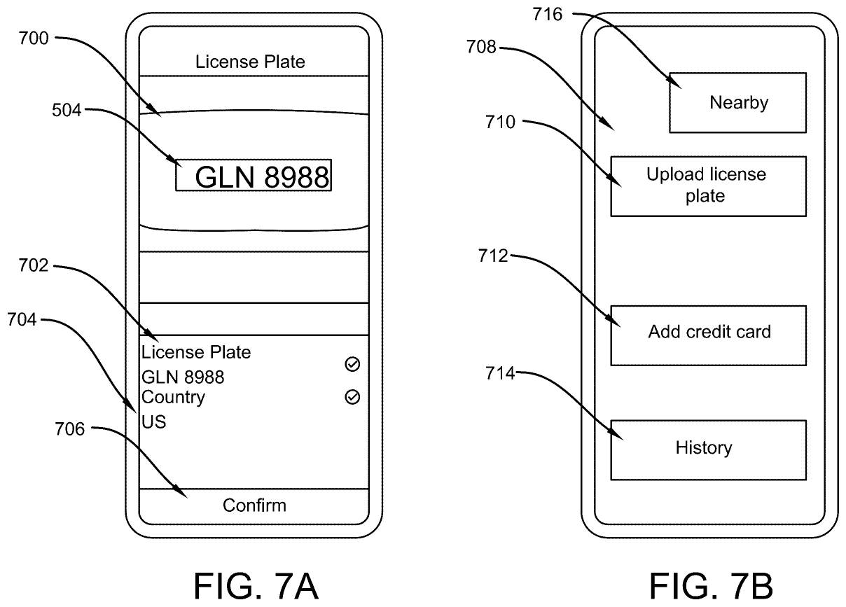

FIG. 7A illustrates an exemplary user interface 700 offered by the license plate payment application of the present invention for selecting and capturing a license plate for the payment in accordance with the disclosed architecture. The application 106 enables a user to scan a license plate 502 using imaging device or camera (positioned on the rear of the mobile device 104). The application 106 may have a built-in scanner for identifying and displaying license plate number 702 and country/state 704 indicating to a user of correct scanning of the license plate 502. Once successfully scanned for registering the license plate 504, a confirmation can be provided by the user using the “Confirm” button 706.

FIG. 7B illustrates another user interface offered by the license plate payment application of the present invention for adding credit card account information for the payment in accordance with the disclosed architecture. In the present embodiment, the user interface 708 displays an “Upload license plate” icon 710 for uploading the captured license plate image as captured in FIG. 7A. The uploaded license plate is registered and associated with the profile of the user and is used for payment by scanning endpoints registered in the system 100. An “Add credit card” button 712 is used for adding one or more credit cards (i.e., account information) or any other prepaid financial cards in the profile of the user and is used for deducting an amount upon scanning of the license plate.

The history button 714 when activated displays payment summaries associated with the license plate or profile of the user. The summaries can be maintained in the database 114 or locally in the application 106. The nearby button 716 displays nearby registered service areas/vendors/facilities/venues and associated fees thereby enabling the user to be aware of the charges of the nearby service areas.

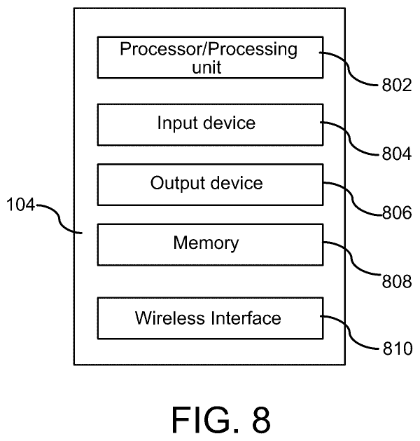

FIG. 8 illustrates the exemplary user device 104 that is used for installing the software application 106 of the present invention in accordance with the disclosed architecture. The processing unit 802 may include suitable logic, instructions, circuitry, interfaces, and/or codes for executing various operations, such as the operations associated with the user device 104, or the like. The processing unit 802 may be configured to control one or more operations executed by the electronic device 104 in response to the input received at the device 104 from the user. The processor 802 executes the computer readable instructions stored in the application 106. Examples of the processing unit 802 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. The electronic device 104 can further include one or more computer executable applications configured to be executed by the processing unit 802. The one or more computer executable applications may include suitable logic, instructions, and/or codes for executing various operations. The one or more computer executable applications may be stored in the memory 808.

The user device 104 includes input device(s) 804 such as a camera, touch input device, voice input device, etc. for entering data and information. Preferably, the touch interface of the user device 104 is used as the input and various buttons/tabs shown on the application 106 are pressed or clicked by the user. The display of the user device 104 also acts as the output device 806 for displaying various contents (i.e., text, images, videos, icons, and/or symbols, etc.) to the user. The display can include a touch screen, and can receive, for example, a touch, gesture, proximity, or hovering input using an electronic pen or a part of a user's body.

Electronic device 104 has memory 808 used for storing programs (sequences of instructions) or data (e.g., program state information) on a temporary or permanent basis for use in the computer system. Memory 808 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 802, in combination with one or more of memory 808, input device(s) 804, output device(s) 806 is utilized to enable users to execute instructions on the application 106. The connection to a network is provided by wireless interface 810. The wireless interface 810 enables the user device 104 to communicate with the server 102 and other components of the system 100.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “mobile application”, “license plate payment application”, “software application”, and “application” are interchangeable and refer to the license plate payment software application 106 of the present invention.

Notwithstanding the forgoing, the license plate payment software application 106 of the present invention can be of any suitable configuration as is known in the art without affecting the overall concept of the invention, provided that it accomplishes the above-stated objectives. One of ordinary skill in the art will appreciate that the license plate payment software application 106 as shown in the FIGS. is for illustrative purposes only, and that many configurations and functionalities of the license plate payment software application 106 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A license plate payment system comprising:
a mobile device connected to a server for using said mobile device to make payment in real time at a remote vehicle location; and
a scanner at a venue for scanning a license plate of the vehicle;
wherein said mobile device having a license plate payment application;
wherein said license plate payment application having stored a payor account;
wherein said license plate payment application having a user interface for the user to register said license plate and said payor account;
wherein said license plate payment application associates said payor account with said license plate of the vehicle;
wherein said scanner upon said scanning of said license plate notifies said mobile device to debit said payor account a payment and to credit the venue said payment;
wherein said license plate payment application having an encrypted registration database for storing said license plate number and said payor account; and
further wherein said encrypted registration database having a linkage between said license plate number and said payor account for said payment module to debit said payor account with said payment upon scanning of said license plate by said scanner.

2. The license plate payment system of claim 1, wherein said payment amount credited to a vendor registered with the system.

3. The license plate payment system of claim 1, wherein said scanning of said license plate with said scanner is at time of entry of the venue.

4. The license plate payment system of claim 1, wherein said scanning of said license plate with said scanner is at time of exit from the venue.

5. The license plate payment system of claim 1, wherein said server connected to a third-party payment module.

6. The license plate payment system of claim 5, wherein said license plate payment application having an uploaded image of said license plate.

7. The license plate payment system of claim 6, wherein said scanner having scanning endpoints for said scanning of said license plate.

8. The license plate payment system of claim 7, wherein when said scanning endpoints scan said license plate, the information of said license plate is received by said server from said scanning endpoints.

9. The license plate payment system of claim 8, wherein said server having an optical character recognition (OCR) module for retrieving a license plate number from said uploaded image of said license plate for authentication.

10. The license plate payment system of claim 9, wherein said payor account is a credit card payment account.

11. A method of processing a payment to a vendor, the method comprising the steps of:
connecting a server to a mobile device for using said mobile device to make payment in real time at a remote vehicle location;
scanning a license plate of a vehicle with a scanner at a venue of the vendor;
providing said mobile device with a license plate payment application;
storing a payor account in said license plate payment application;
registering said license plate and said payor account with said license plate payment application;
associating said payor account with said license plate of the vehicle in said license plate payment application;
notifying said mobile device to debit said payor account a payment and to credit the venue said payment upon said scanning of said license plate;
storing said license plate number and said payor account in an encrypted registration database of said license plate payment application; and
linking said license plate number and said payor account for said payment module to debit said payor account with said payment upon scanning of said license plate by said scanning end point.

12. The method of claim 11, wherein said payment amount credited to a vendor registered with the system.

13. The method of claim 11, wherein said scanning of said license plate with said scanner is at time of entry of the venue.

14. The method of claim 11, wherein said scanning of said license plate with said scanner is at time of exit from the venue.

15. The method of claim 11, wherein said server connected to a third-party payment module.

16. The method of claim 15, wherein said license plate payment application having an uploaded image of said license plate.

17. The method of claim 16, wherein said server having an optical character recognition (OCR) module for retrieving a license plate number from said uploaded image of said license plate for authentication.

18. The method of claim 17, wherein said payor account is a credit card payment account.

19. A method of processing a license plate payment to a vendor, the method comprising the steps of:
downloading a license plate payment application in an electronic mobile device by a user;
connecting a server to a mobile device for using said mobile device to make payment in real time at a remote vehicle location;
providing said mobile device with said license plate payment application;
storing a payor account in said license plate payment application;
uploading an image of said license plate to said license plate payment application;
registering said license plate and said payor account with said license plate payment application;
associating said payor account with said license plate of the vehicle in said license plate payment application;
scanning a license plate of a vehicle with a scanner at a venue of the vendor;
notifying said mobile device to debit said payor account a payment and to credit the venue said payment upon said scanning of said license plate;
storing said license plate and said payor account in an encrypted registration database of said license plate payment application; and
linking said license plate number and said payor account for said payment module to debit said payor account with said payment upon scanning of said license plate by said scanner.

20. The method of claim 19, wherein said server having an optical character recognition (OCR) module for retrieving a license plate number from said uploaded image of said license plate for authentication.
